(19) United States
(12) Patent Application Publication
(10) Pub. No.: US 2026/0118142 A1
(43) Pub. Date: Apr. 30, 2026

(54) Method for Correcting Measurement Signals

(71) Applicant: Robert Bosch GmbH, Stuttgart (DE)

(72) Inventor: Stefan Kuntz, Flein (DE)

(21) Appl. No.: 19/371,784

(22) Filed: Oct. 28, 2025

(30) Foreign Application Priority Data
Oct. 29, 2024 (DE) 10 2024 210 395.0

(51) Int. Cl. G01D 5/244; G01D 3/036

(52) U.S. Cl. CPC G01D 5/24495; G01D 3/036; G01D 5/2449

(57) ABSTRACT

A method for correcting at least two measurement signals includes currently providing at least two currently provided measurement signals by at least one sensor unit. The method further includes, based on the at least two currently provided measurement signals, (i) generating at least two processed measurement signals, and (ii) generating two corrected measurement signals from the at least two processed measurement signals using angle-independent calculation operations and at least one correction coefficient, from which a corrected angle is calculated. In order to determine the at least one correction coefficient (i) a plurality of advance provided measurement signals is provided in advance, (ii) based on the plurality of advance provided measurement signals, two processed advance measurement signals are generated in each case, and (iii) a corresponding angular error is calculated based on the two processed advance measurement signals and a reference angle.

This application claims priority under 35 U.S.C. § 119 to patent application no. DE 10 2024 210 395.0, filed on Oct. 29, 2024 in Germany, the disclosure of which is incorporated herein by reference in its entirety.

The disclosure relates to a method for correcting measurement signals. The measurement signals may, for example, represent a rotary motion of a body detected by a sensor array or a current angular position of the moving body. An object of the disclosure is also a sensor array which is designed to carry out such a method.

### BACKGROUND

Sensor arrays are known from prior art which are used as rotary motion sensors to detect a rotary motion of a moving body or as linear displacement sensors to detect a linear motion of the moving body. Here, the current angular position of the moving body in the rotary motion or the current position of the moving body in the linear motion is not directly measured, but rather encoded in two orthogonal signals, which are commonly referred to as the sine channel and cosine channel and form a vector in the complex plane. The actual angular position of the moving body or the current position of the moving body is then calculated using the arctangent function, wherein Cartesian coordinates may essentially be converted into a polar angle. Sine signals and/or cosine signals provided by the sensor arrays may be faulty and may, for example, have an offset, an amplitude mismatch, an orthogonality error, non-linearities, etc. These errors may be corrected, for example, by an analog evaluation and control unit or digitally by a corresponding evaluation program. In order to minimize the angular error, the corresponding correction coefficients should be calculated or determined as accurately as possible. For example, it is known to calculate the correction coefficients using a Fourier transform of the sine signals and/or cosine signals provided by the sensors. As the current angular position or the current position is calculated and not measured directly, a distinction is made between a signal range and an angular range. Here, harmonic disturbances with a certain order in the signal range may also lead to harmonics in the angular range, but in a different order. The cause of this type of error depends on the measuring principle and is most often caused by manufacturing tolerances and imperfections in the sensor design, for example, non-ideal magnetization and flux distribution in magnetic sensors.

DE 102 60 862 A1 discloses a method and a circuit array for correcting an angle and/or distance-measuring sensor array in which sine and cosine measurement signals are evaluated. The measurement signals are obtained by scanning a moving measurement object. The angular errors or phase errors of the measurement signals are corrected by deriving constants for estimating and correcting the angular error or phase error and/or the amplitude of the measurement signals from a plurality of measurement signals.

DE 10 2004 029 815 A1 discloses a method and an array for correcting an angle- and/or distance-measuring sensor array in which sine and cosine measurement signals obtained by scanning a moving measurement object are evaluated. To correct the angular errors and/or phase errors of the measurement signals, the method consists of an adjustment procedure and a subsequent correction procedure. Correction parameters are provided in the adjustment procedure and a corrected pair of measured values is ascertained from each pair of measured values in the correction procedure.

### SUMMARY

The method for correcting measurement signals with the features disclosed herein has the advantage that correction coefficients may be calculated in such a way that the angular error is reduced, preferably minimized, after the correction. Embodiments of the method may also be used for “difficult” measurement signals in which angular errors arise from harmonics of sine signals and/or cosine signals. The correction coefficients calculated using conventional methods are distorted by such harmonics, such that an achievable minimum of the angular error cannot be achieved.

Embodiments of the disclosure perform an iterative calculation or determination of correction coefficients, which enable a compensation of electrical harmonic oscillations of first and/or second order in the angular error, even if these are not or not exclusively caused by offset, amplitude mismatch or orthogonality error, but, for example, by second or third electrical harmonic oscillations or harmonics of the encoder signals or sine signals and/or cosine signals. Here, the measurement signals or encoder signals may also be provided by multiphase systems with more than two measurement signals or encoder signals, which may be transformed into the complex plane after appropriate transform (e.g., Clarke transform). For a periodicity that is greater than the value “1”, a distinction is made between a mechanical and an electrical angle, which deviates from the mechanical angle by the factor of the periodicity.

Embodiments of the disclosure provide a method for correcting measurement signals. Here, at least two measurement signals are provided by at least one sensor unit. Based on the at least two measurement signals currently provided, at least two conditioned measurement signals are generated, from which two corrected measurement signals are generated using angle-independent calculation operations and at least one correction coefficient, from which a corrected angle is calculated.

To determine the at least one correction coefficient, a plurality of at least two measurement signals is provided in advance. Based on the plurality of at least two measurement signals provided in advance, two processed measurement signals are generated in each case. A corresponding angular error is calculated based on the two processed measurement signals and a reference angle. At least one correction parameter is determined based on at least one step of a calculation method that can be applied iteratively. Based on the at least one correction parameter, the at least one correction coefficient is determined such that a remaining angular error in the corrected angle is smaller than an angular error in an angle based on the two processed measurement signals.

In addition, a sensor array is proposed which comprises at least one sensor unit and at least one evaluation and control unit and is designed to carry out such a method.

Embodiments of the disclosure introduce a first and second order electrical harmonic oscillation into the angular error, which counteract and cancel the corresponding harmonic oscillation present in the angular error. The amplitude and phase of the generated harmonic oscillations may be controlled by selecting the appropriate correction coefficients for offset, amplitude mismatch, and orthogonality. It is particularly advantageous that the calculated correction coefficients may be applied independently of the angle, which, in contrast to known harmonic compensation methods, avoids a computationally complex evaluation of trigonometric functions at the time of correction. The angle-independent application here means that the calculation operations are independent, for example, of the corrected angle or the angle based on the two processed measurement signals, when applying the correction coefficients. However, the use of trigonometric angle functions for correction is of course possible. An angle-dependent correction, for example, a harmonic correction, may also be carried out in addition, for example, before or after or in parallel to the angle-independent method described.

In the following, the iterative calculation method can be understood as a calculation method that only has a single iteration step but can also be applied iteratively. Thus, the disclosure is based on an iterative determination of at least one correction coefficient to compensate for an offset of the processed measurement signals. A single step of the iterative calculation method may be sufficient. Further correction coefficients to compensate for an amplitude mismatch and/or an orthogonality error and/or an angular offset can then be determined after applying the previously calculated correction coefficient for offset correction in further steps of the iteratively applicable calculation method.

The at least one correction coefficient can be determined by solving a non-linear optimization problem to minimize the sum of the squared angular errors. Compared to standard methods for solving optimization problems, which are very complex to implement and require significant resources or computing power on a control unit, embodiments of the disclosure can advantageously perform an analytical approximation of an inverse Hessian matrix of the optimization problem. This can significantly simplify the implementation without impairing the convergence and accuracy of the calculation method.

In the present case, an evaluation and control unit may be understood as an electrical assembly or electrical circuit or an electrical device, such as a control unit, which conditions or processes or evaluates the sensor signals provided. For example, the evaluation and control unit may comprise an ASIC assembly (ASIC: application-specific integrated circuit) or a microcontroller. The evaluation and control unit may comprise at least one interface, which may be implemented as hardware and/or software. When implemented as hardware, the interfaces may be part of the ASIC assembly, for example. However, it is also possible that the interfaces are dedicated integrated circuits or consist at least partly of discrete components. When implemented as software, the interfaces may be software modules present, for example, on a microcontroller alongside other software modules. A computer program product comprising program code stored on a machine-readable medium such as a semiconductor memory, a hard disk memory or an optical memory and used to perform the evaluation and to determine the at least one correction coefficient when the program is executed by the evaluation and control unit is also advantageous.

In the present case, a sensor unit is understood to be a structural unit which comprises at least one sensor element which directly or indirectly provides a physical variable or a change in a physical variable and preferably converts it into an electrical sensor signal. For example, magnetic and/or inductive sensor elements may be used.

Embodiments of the disclosure can preferably be used in a vehicle, for example for detecting a steering angle or for detecting a pedal actuation and for detecting a corresponding actuation path.

It is particularly advantageous that a transform and/or filtering of the at least two previously provided measurement signals and/or the at least two currently provided measurement signals may be carried out when conditioning the plurality of at least two previously provided measurement signals and/or the at least two currently provided measurement signals. For example, a first conditioned measurement signal from at least two previously provided measurement signals and a first conditioned measurement signal from at least two currently provided measurement signals may each be based on a periodic sine function with a predefined period and assigned to a sine channel. A second conditioned measurement signal from at least two previously provided measurement signals and a second conditioned measurement signal from at least two currently provided measurement signals may each be based on a periodic cosine function with the specified period and assigned to a cosine channel. Such a transform may, for example, also include a “rudimentary” compensation of a known offset of the measurement signals, especially if this is determined by the design. The design-related offset may be caused, for example, by the offset of an analog-to-digital conversion, especially in non-differential signal transmission.

In an advantageous embodiment of the method, the angular error can be minimized by the at least one correction coefficient determined by iterative application of the calculation method. This means that the iterative calculation method can be used, for example, until the change in at least one correction coefficient has a minimum value.

In a further advantageous embodiment of the method, an iterative Newton method can be used as an iterative calculation method, which is based on a first partial derivation of a sum of squares of the angular error with respect to the at least one correction parameter or a variable based thereon or an approximation of a variable based thereon.

In a further advantageous embodiment of the method, the calculation of the at least one correction parameter can be based on at least one division of at least two cumulative sums. Here, the at least two cumulative sums can be based on the plurality of at least two measurement signals provided in advance and/or the previous and/or the current correction parameters and/or an associated angular error. When the method is used in a rotary motion sensor for detecting a rotary motion of a moving body, the plurality of at least two measurement signals provided in advance can preferably relate to a complete mechanical rotation of the moving body by 360 degrees. When the method is used in a linear position sensor for detecting a linear motion of the moving body, the plurality of at least two measurement signals provided in advance can preferably relate to a complete movement range of the linear motion of the moving body.

In a further advantageous embodiment of the method, a fixed number of steps of the iterative Newton method can be specified. This makes the method particularly easy to implement. Alternatively, the number of steps of the iterative Newton method may be dependent on an evaluation of the plurality of calculated angular errors. The evaluation can comprise an evaluation of harmonic components of the angular error. As a further alternative, the number of steps of the iterative Newton method can be dependent on an evaluation of the correction parameters determined in successive steps of the iterative Newton method. This means that the iterative Newton method can preferably be terminated if the angular error is not further reduced by the correction parameter determined in the subsequent step.

In a further advantageous embodiment of the method, an initial correction parameter can be specified, preferably estimated, before a first step of the iterative Newton method.

In a further advantageous embodiment of the method, the plurality of calculated angular errors or the correction parameters determined in successive steps of the iterative Newton method can be subjected to at least one mathematical operation during the evaluation and the result of the at least one mathematical operation can be compared with a corresponding threshold value. The iterative Newton method can be terminated if the result of at least one mathematical operation falls below the corresponding threshold value.

In a further advantageous embodiment of the method, the iterative Newton method may employ diagonal approximation of an inverse Hessian matrix or an approximation of the diagonal approximation of the inverse Hessian matrix. At least two correction coefficients can be determined here, which are suitable for compensating a portion of the angular error based on a harmonic oscillation with the order “p”. For example, a first correction coefficient can be determined, which is suitable for compensating for an offset error in a first processed measurement signal. In addition, a second correction coefficient can be determined, which is suitable for compensating for an offset error in a second processed measurement signal. Furthermore, at least one additional correction coefficient can be determined, which is suitable for compensating a first portion of the angular error based on a harmonic oscillation with the order “2p”. For example, a third correction coefficient can be determined, which is suitable for compensating for an amplitude mismatch in the at least two processed measurement signals. In addition, at least one further correction coefficient can be determined, which is suitable for compensating a second portion of the angular error based on a harmonic oscillation with the order “2p”. For example, a fourth correction coefficient can be determined, which is suitable for compensating for an orthogonality error in the at least two processed measurement signals. Here, the value “p” corresponds to the period of the first and second conditioned measurement signal.

The angular error can also be subjected to a discrete Fourier transform. At least one further correction coefficient can be determined based on the coefficients of the discrete Fourier transform. The at least one further correction coefficient can be suitable for compensating for at least one portion of the angular error based on a harmonic oscillation with the order “2p”. As an alternative to determining the third and fourth correction coefficients using the iteratively applicable calculation method, the third and fourth correction coefficients, which are suitable for compensating a first portion of the angular error based on a harmonic oscillation with the order “2p”, can be determined based on a third coefficient of the discrete Fourier transform. The first portion may, for example, correspond to an imaginary part of order “2p” of the Fourier-transformed angular error. The third correction coefficient can correspond to an equivalent relative amplitude of the sine channel. The fourth correction coefficient can correspond to an equivalent relative amplitude of the cosine channel. The fourth and fifth correction coefficients may also be combined into a common correction value, which represents the ratio of the two correction coefficients.

In a further advantageous embodiment of the method, at least one correction coefficient can also be determined, which is suitable for compensating a portion of the angular error based on an angular offset error. For example, a fifth correction coefficient can be calculated as the mean value of the angular errors of the plurality of at least two measurement signals provided in advance.

Exemplary embodiments of the disclosure are shown in the drawings and explained in more detail in the following description. In the drawings, identical reference numerals refer to components or elements performing identical or similar functions.

### BRIEF DESCRIPTION OF THE DRAWINGS

FIG. 1 shows a schematic flow diagram of an exemplary embodiment of a method according to the disclosure for correcting measurement signals;

FIG. 2 shows a schematic representation of an exemplary embodiment of a sensor array according to the disclosure when determining correction coefficients during the execution of the method according to the disclosure from FIG. 1; and

FIG. 3 shows a schematic representation of the sensor array according to the disclosure when correcting measurement signals during the execution of the method according to the disclosure from FIG. 1.

### DETAILED DESCRIPTION

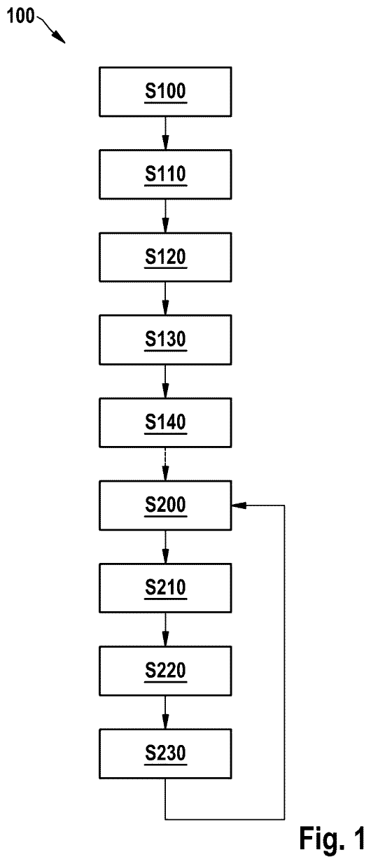

As is evident from FIGS. 1 to 3, the exemplary embodiment shown of a method 100 according to the disclosure for correcting measurement signals MS1, MS2, MS3 comprises a step S200 in which at least two measurement signals MS1, MS2, MS3 are currently provided by at least one sensor unit 3. In a step S210, at least two processed measurement signals a, b are generated based on the at least two currently provided measurement signals MS1, MS2, MS3, from which two corrected measurement signals ac, bc are generated in a step S220 using angle-independent calculation operations and at least one correction coefficient K, from which a corrected angle WK is calculated in a step S230. The method then returns to step S200. In addition, the calculated angle WK can be output to higher-level vehicle functions in step S230 when used in a vehicle.

To determine the at least one correction coefficient K, a plurality N of at least two measurement signals MS1ⱼ, MS2ⱼ, MS3ⱼ is provided in advance in a step S100. Based on the plurality N of at least two measurement signals MS1ⱼ, MS2ⱼ, MS3ⱼ provided in advance, two processed measurement signals aⱼ, bⱼ are generated in a step S110. Based on the two processed measurement signals aⱼ, bⱼ and a reference angle WR, a corresponding angular error dWⱼ is calculated in step S120. Based on at least one step of an iteratively applicable calculation method, at least one correction parameter Pᵢ is determined in a step S130. In a step S140, based on the at least one correction parameter Pᵢ the at least one correction coefficient K is determined such that a remaining angular error dW in the corrected angle WK is smaller than an angular error dW in an angle W which is based on the two processed current measurement signals a, b.

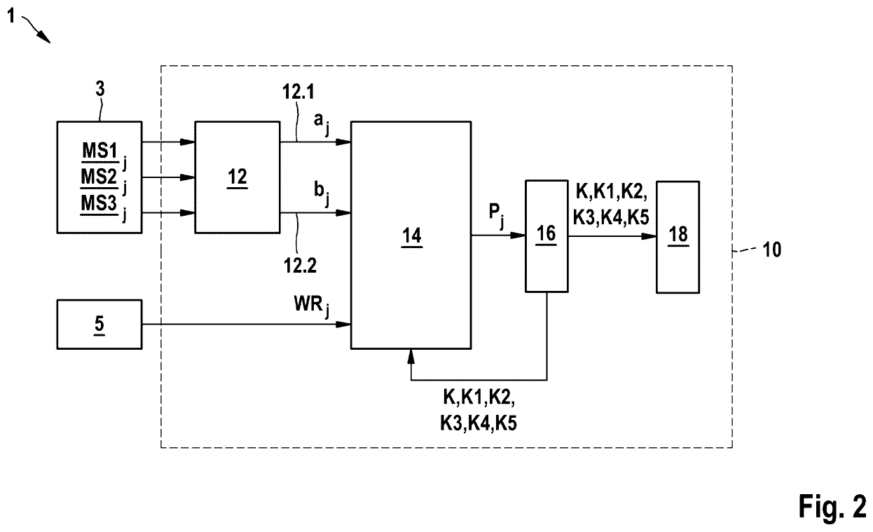

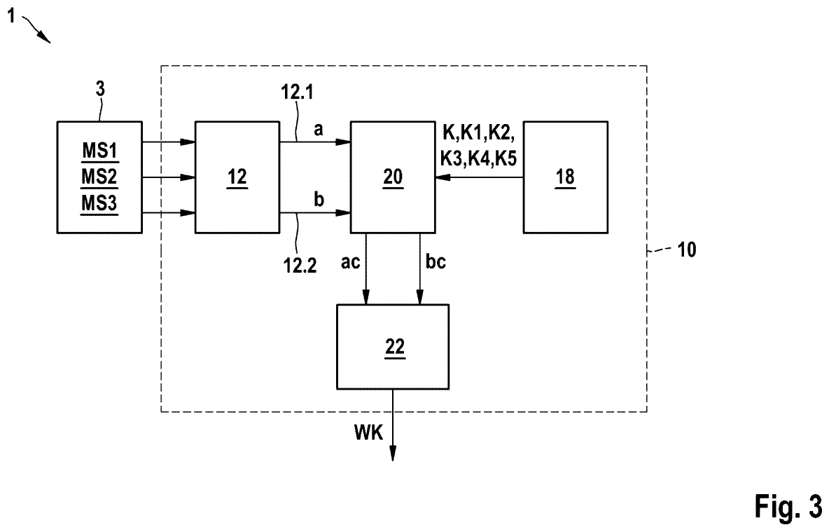

As is further evident from FIGS. 2 and 3, the exemplary embodiment shown of the sensor array 1 according to the disclosure comprises at least one sensor unit 3 and at least one evaluation and control unit 10 and is designed to carry out the method 100 according to the disclosure. In the exemplary embodiment shown, the sensor array 1 comprises only a sensor unit 3 and only an evaluation and control unit 10 having several function blocks for executing the method 100.

As is further evident from FIG. 2, the sensor unit 3 provides three measurement signals MS1ⱼ, MS2ⱼ, MS3ⱼ for determining the at least one correction coefficient, K for a plurality N of scans or measurements in the exemplary embodiment shown. When processing the plurality N of three measurement signals MS1ⱼ, MS2ⱼ, MS3ⱼ provided in advance, a Clarke transform of the three measurement signals MS1ⱼ, MS2ⱼ provided in advance is performed in a first transform block 12, MS3ⱼ into a first processed measurement signal aⱼ based on a periodic sine function with a predetermined period “p” and into a second processed measurement signal bⱼ based on a periodic cosine function with the predetermined period “p”. Here, the first conditioned measurement signal aⱼ is assigned to a sine channel 12.1, and the second conditioned measurement signal bⱼ is assigned to a cosine channel 12.2.

As an iterative calculation method for determining the at least one correction coefficient K, a first calculation block 14 of the evaluation and control unit 10 in the illustrated exemplary embodiment uses an iterative Newton method, which is based on a first partial derivation of a sum of squares of the angular error dWⱼ with respect to the at least one correction parameter Pᵢ or a variable based thereon or an approximation of a variable based thereon. Here, the sum of the squared angular errors dWⱼ is preferably minimized by the at least one correction coefficient K determined by iterative application of the calculation method. In the exemplary embodiment shown, the at least one correction parameter Pᵢ corresponds to a correction vector. One step of the iteratively applicable calculation method results in the illustrated exemplary embodiment of the method 100 according to the disclosure according to equation (1).

$${P}_{k + 1} = {P}_{k} - [ \begin{matrix}D 1 \\ D 2 \\ D 3 \\ D 4\end{matrix} ] \qquad ( 1 )$$

Here, Pₖ₊₁ is the new estimate for the at least one correction parameter Pᵢ, and Pₖ is the previous estimate of the at least one correction parameter Pᵢ or an initial start value P₀ of the at least one correction parameter Pᵢ.

The calculation of at least one correction parameter Pᵢ is based on at least one division of at least two cumulative sums. Here, the at least two cumulative sums are based on the plurality N of at least two measurement signals MS1ⱼ, MS2ⱼ, MS3ⱼ provided in advance and/or the previous and/or current correction parameters Pᵢ and/or an associated angular error dWⱼ. The iterative calculation method or the iterative Newton method is terminated, for example, by convergence or depending on a number of iteration steps. For example, the number of iteration steps can be fixed. Alternatively, the number of steps of the iterative Newton method depends on an evaluation of the plurality N of calculated angular errors dWⱼ. The evaluation comprises, for example, an evaluation of harmonic components of the angular error dWⱼ. In a further alternative, the number of steps of the iteratively applicable calculation method or the iterative Newton method depends on an evaluation of the correction parameters Pᵢ determined in successive steps of the iterative Newton method. During the evaluation, the plurality N of calculated angular errors dWⱼ or the correction parameters Pᵢ determined in successive steps of the iterative Newton method are subjected to at least one mathematical operation and the result of the at least one mathematical operation is compared with a corresponding threshold value. The iterative calculation method or the iterative Newton method is terminated if the result of at least one mathematical operation falls below the corresponding threshold value.

In the exemplary embodiment shown, four divisions D1, D2, D2, D4 of two cumulative sums each are used in accordance with equations (2), (3), (4), (5) to calculate the at least one correction parameter Pᵢ.

$$K 1 = D 1 = \frac{S 1}{S 2} = \frac{{\sum }_{j = 1}^{N} {dW}_{j} ( \frac{{ac}_{j}}{{n}_{j}^{2}} )}{{\sum }_{j = 1}^{N} ( \frac{{ac}_{j}^{2}}{{n}_{j}^{4}} )} \qquad ( 3 )$$

$$K 2 = D 2 = \frac{S 3}{S 4} = \frac{{\sum }_{j = 1}^{N} {dW}_{j} ( \frac{- {bc}_{j}}{{n}_{j}^{2}} )}{{\sum }_{j = 1}^{N} ( \frac{{bc}_{j}^{2}}{{n}_{j}^{4}} )} \qquad ( 2 )$$

$$K 3 = D 3 = \frac{S 5}{S 6} = \frac{{\sum }_{j = 1}^{N} {dW}_{j} ( \frac{{ac}_{j} {bc}_{j}}{{n}_{j}^{2}} )}{{\sum }_{j = 1}^{N} ( \frac{{ac}_{j}^{2} {bc}_{j}^{2}}{{n}_{j}^{4}} )} \qquad ( 4 )$$

$$K 4 = D 4 = \frac{S 7}{S 8} = \frac{{\sum }_{j = 1}^{N} {dW}_{j} ( \frac{{ac}_{j}^{2} {bc}_{j}^{2}}{{n}_{j}^{2}} )}{{\sum }_{j = 1}^{N} ( \frac{{( {ac}_{j}^{2} {bc}_{j}^{2} )}^{2}}{{n}_{j}^{4}} )} \qquad ( 5 )$$

Here acⱼ is a corrected processed first measured value, bcⱼ is a corrected processed second measured value and nⱼ is a vector length of a vector, which results according to equation (6) from the corrected processed first measured value acⱼ and the corrected processed second measured value bcⱼ and is calculated by the calculation block 14 of the evaluation and control unit 10.

$${n}_{j} = \sqrt{{ac}_{j}^{2} - {bc}_{j}^{2}} \qquad ( 6 )$$

Preferably, common factors, such as the squared vector length nⱼ, the fourth power of the vector length nⱼ and/or the factors (acⱼ*bcⱼ) or ((acⱼ)²*(bcⱼ)²) are calculated only once per angular position or “value pair” aⱼ, bⱼ by the calculation block 14 of the evaluation and control unit 10 and then reused.

The sums S1, S2, S3, S4, S5, S6, S7, S8 in equations (2) to (5) are cumulatively added up in each of the individual iteration steps during a movement over the measuring range and evaluated at the end of the measuring range in order to obtain the new estimate for the at least one correction parameter Pᵢ of the corresponding iteration step. Preferably, the scanning takes place during the movement at regular intervals in relation to the reference angle WRⱼ or the measurement signals MS1ⱼ, MS2ⱼ, MS3ⱼ or the processed measurement signals aⱼ, bⱼ are interpolated to regular intervals. After each step of the iterative calculation method or the iterative Newton method, the at least one correction coefficient K is determined and evaluated in a determination block 16 of the evaluation and control unit 10 on the basis of the at least one correction parameter Pᵢ. If the determined at least one correction coefficient K fulfills the above conditions, the iterative calculation method or the iterative Newton method is terminated. Here, the iterative calculation method or the iterative Newton method can already be terminated after the first step if the at least one correction coefficient K based on the initial starting value P₀ of the at least one correction parameter Pᵢ fulfills the conditions. If the determined at least one correction coefficient K does not meet the above conditions, the iterative calculation method or the iterative Newton method is continued with the next iteration step. After completion of the iterative calculation method or the iterative Newton method, the at least one correction coefficient K is output and preferably stored in a memory 18. Iteration steps following the first iteration step can be carried out with new measurement signals MS1ⱼ, MS2ⱼ, MS3ⱼ recorded during a mechanical movement. Alternatively, the measurement signals MS1ⱼ, MS2ⱼ, MS3ⱼ and/or the processed measurement signals aⱼ, bⱼ of a previous iteration step can also be reused in a subsequent iteration step and these can be stored in a buffer, for example. In particular, this saves a new mechanical movement and offers the advantage that the method can be carried out in a shorter time, for example.

In the illustrated exemplary embodiment, a first correction coefficient K1 is determined by a first division D1 of a first sum S1 and a second sum S2 according to equation (2). A second correction coefficient K2 is determined by a second division D2 of a third sum S3 and a fourth sum S4 according to equation (3). Here, the first and second correction coefficients K1, K2 are suitable for compensating a portion of the angular error dWⱼ based on a harmonic oscillation with the order “p”. Here, the value “p” corresponds to a number of periods of the first and second processed measurement signal aⱼ, bⱼ. The first correction coefficient K1 is used to compensate for an offset error in the processed first measurement signal aⱼ. The second correction coefficient K2 is used to compensate for an offset error in the processed second measurement signal bⱼ.

A third correction coefficient K3 is determined by a third division D3 of a fifth sum S5 and a sixth sum S6 according to equation (4). The third correction coefficient K3 is suitable for compensating a first portion of the angular error dWⱼ based on a harmonic oscillation with the order “2p”. The third correction coefficient K3 is used to compensate for an amplitude mismatch in the at least two processed measurement signals aⱼ, bⱼ. Here, the value “p” corresponds to a number of periods of the first and second processed measurement signal aⱼ, bⱼ.

A fourth correction coefficient K4 is determined by a fourth division D4 of a seventh sum S7 and an eighth sum S8 according to equation (5). The fourth correction coefficient K4 is suitable for compensating a second portion of the angular error dWⱼ based on a harmonic oscillation with the order “2p”. The fourth correction coefficient K4 is used to compensate for an orthogonality error in the at least two processed measurement signals aⱼ, bⱼ. Here, the value “p” corresponds to a number of periods of the first and second processed measurement signal aⱼ, bⱼ.

In the illustrated exemplary embodiment of the method 100, the four correction coefficients K1, K2, K3, K4 are used to calculate the corrected conditioned first measurement signal acⱼ according to equation (7) and the corrected conditioned second measurement signal bcⱼ according to equation (8). In this exemplary embodiment, the processed second measurement signal bⱼ serves as a reference for the amplitude and orthogonality and is therefore only offset-compensated using the second correction coefficient K2. This choice is arbitrary. Of course, it is also possible to select the processed first measurement signal aⱼ as the amplitude and orthogonality reference. Alternatively, an amplitude mismatch and an orthogonality error can also be applied proportionally to the processed first measurement signal aⱼ and the processed second measurement signal bⱼ instead. It is also possible, for example, to correct an amplitude mismatch indirectly by correcting the absolute amplitudes of the processed first measurement signal aⱼ and the processed second measurement signal bⱼ.

$${ac}_{j} = K 3 ( {a}_{j} - K 1 ) - K 4 {bc}_{j}$$

$${bc}_{j} = ( {b}_{j} - K 2 )$$

When the iteratively applicable calculation method or the iterative Newton method is carried out by the calculation block 14 of the evaluation and control unit 10, an initial correction parameter P₀ is specified, preferably estimated, before a first step of the iteratively applicable calculation method or the iterative Newton method. The initial correction parameter P₀ is used to correct the corresponding first N processed first and second measurement signals aᵢ, bᵢ sampled during a first movement over the measurement range, calculate the first N corrected conditioned first measurement signals acᵢ according to equation (7) and calculate the first N corrected conditioned second measurement signals bc; according to equation (8). The electrical angular error dWⱼ for a corresponding sensing j is calculated according to equation (9). The calculation is performed in the calculation block 14 of the evaluation and control unit 10 based on the corrected processed first measurement signal acⱼ of the sine channel 12.1 and the corrected processed second measurement signal bcⱼ of the cosine channel 12.2, taking into account a corresponding reference angle WRⱼ provided. The reference angle WRⱼ can, for example, be provided by a drive of a moving body whose angular position is to be determined.

$${dW}_{j} = ( arctan ( \frac{{ac}_{j ( W )}}{{bc}_{j ( W )}} ) ) - ( p * {WR}_{j} ) \qquad ( 9 )$$

Equation (9) is only valid for a limited range of the electrical angle W, as the quadrants are ambiguous and may be divided by zero. In practice, this problem is solved by a modified arctangent function with two arguments, known as atan2 (aⱼ, bⱼ). Here, the arctan result is unpacked (“unwrapped”) to remove the influence of discontinuities.

In the exemplary embodiment shown, the iterative Newton method uses a diagonal approximation of an inverse Hessian matrix or an approximation of the diagonal approximation of the inverse Hessian matrix. This means that a numerically complex inversion of the Hessian matrix or the solution of a linear system of equations can be avoided. Instead, the cumulative sums D1, D2, D3, D4, which are easy to calculate, are used. The diagonal approximation simplifies the inversion of the matrix to a simple division. The initial correction parameter P₀ is an example of a vector (10) that corresponds to an identity correction. To further simplify the cumulative sums D1, D2, D3, D4, the partial derivatives for the Newton method can be calculated under the assumption that the correction parameters P₀ correspond to the vector (10). This does not significantly affect the convergence of the method.

$${P}_{0} = [ \begin{matrix}0 \\ 0 \\ 1 \\ 0\end{matrix} ] \qquad ( 10 )$$

Based on the vector (10), the first correction coefficient K1, the second correction coefficient K2 and the fourth correction coefficient K4 each have the value “0”. The third correction coefficient K3 has the value “1”. As a result, the corrected conditioned first measurement signal acⱼ before the first iteration step corresponds to the conditioned first measurement signal aⱼ and the corrected conditioned second measurement signal bcⱼ before the first iteration step corresponds to the conditioned second measurement signal bⱼ.

In the exemplary embodiment shown, the determination block 16 additionally determines a fifth correction coefficient K5, which is suitable for compensating a portion of the angular error dWⱼ based on an angular offset error. To avoid numerical problems, the angular error in the cumulative sums D1, D2, D3, D4 can be advantageously corrected with the fifth correction coefficient K5, in particular by subtracting K5. A particularly advantageous alternative or addition to unwrapping the angular error is to add the value “pi” to the calculated angular error, normalize the result modulo “2*pi” and then subtract the value “pi” again, as can be seen from equation (9A). With a suitable choice of the fifth correction coefficient K5, explicit unwrapping can be avoided in many cases. The fifth correction coefficient K5 is advantageously selected so that the offset of the angular error is as small as possible. For example, K5 can be determined using the first observed, uncorrected angular error. Subsequently calculated angular errors can then be corrected directly with K5.

$${dW}_{j} = ( ( ( arctan ( \frac{{ac}_{j ( W )}}{{bc}_{j ( W )}} ) ) - ( p * {WR}_{j} ) - K 5 + π ) mod 2 π ) - π \qquad ( 9 A )$$

In an alternative exemplary embodiment of the method 100, which is not shown, only the first correction coefficient K1 and the second correction coefficient K2 are determined using the iteratively applicable calculation method or the iterative Newton method. To determine the third correction coefficient K3 and the fourth correction coefficient K4, the angular error dWⱼ is subjected to a discrete Fourier transform DFT. For this purpose, the evaluation and control unit 10 subjects the angular error dWⱼ to the discrete Fourier transform DFT in a transform block not shown in detail and calculates the coefficients X[0], X[p], X[2p], which are used to determine the third correction coefficient K3 and the fourth correction coefficient K4. From the amplitude-normalized discrete Fourier transform DFT of the angular error dWⱼ over N samples over the entire mechanical measuring range, the coefficients X[0], X[p], X[2p] of the discrete Fourier transform DFT are calculated according to equations (11) and (12).

$$X = DFT \{ {dW}_{j} \} \qquad ( 11 )$$

$$X [ k ] = \{ \begin{matrix}\frac{1}{N} {\sum }_{j = 0}^{N - 1} {dW}_{j} & k = 0 \\ \frac{2}{N} {\sum }_{j = 0}^{N - 1} {dW}_{j} {e}^{- 2 π i \frac{jk}{N}} & k > 0\end{matrix} \qquad ( 12 )$$

Here, a real part of “X[0]” is equal to the mean value of the angular error dWⱼ. The magnitude of “X[k]” is equal to the amplitude of a sine curve of the kth harmonic oscillation, provided that the angular error dWⱼ is real, where “i” is the imaginary unit. To calculate the third correction coefficient K3 and the fourth correction coefficient K4, a third coefficient X[2p] of the discrete Fourier transform DFT is used, which is based on a harmonic oscillation with the order “2p”. Here, the value “p” corresponds to the period p of the first and second conditioned measurement signals aⱼ, bⱼ.

Preferably, the discrete Fourier transform DFT is performed in several cumulative sums of the individual angular errors dWⱼ calculated from the two corrected processed measurement signals acⱼ, bcⱼ, which are based on the plurality N of the three processed measurement signals aⱼ, bⱼ, which in turn are based on the three previously provided measurement signals MS1ⱼ, MS2ⱼ, MS3ⱼ. Alternatively, the discrete Fourier transform DFT can be applied to the totality of the respective angular errors dWⱼ calculated from the two corrected processed measurement signals acⱼ, bcⱼ.

According to equation (13), the fifth correction coefficient K5 corresponds to a real part RE of the first coefficient X[0] of the discrete Fourier transform DFT and is calculated as the mean value of the angular errors dWⱼ. The individual angular errors dWⱼ are determined based on an angle W, which is determined from the plurality N of the corrected processed measurement signals acⱼ, bcⱼ and the corresponding reference angle WRⱼ in each case. The fifth correction value K5 can be interpreted as an average angular deviation between the measured angle W and the reference angle WRⱼ which can be caused, for example, by the installation of the sensor unit 3.

$$K 5 = Re \{ X [ 0 ] \} \qquad ( 13 )$$

Based on the third coefficient X[2p] of the discrete Fourier transform DFT and the fifth correction coefficient K5, the third correction coefficient K3 is calculated according to equation (14). In the exemplary embodiment shown, the first correction coefficient K1 and the second correction coefficient K2 are also taken into account when calculating the improved third correction coefficient K3′ in accordance with equation (14A).

$$K 3 = \frac{1 - Im \{ X [ 2 p ] {e}^{- i 2 ( K 5 )} \}}{1 + Im \{ X [ 2 p ] {e}^{- i 2 ( K 5 )} \}} cos ( K 4 ) \qquad ( 14 )$$

$$K {3}^{′} = \frac{1 - ( Im \{ X [ 2 p ] {e}^{- i 2 ( K 5 )} \} + \frac{1}{2} ( {( K 2 )}^{2} - {( K 1 )}^{2} ) )}{1 - Im \{ X [ 2 p ] {e}^{- i 2 ( K 5 )} \} + \frac{1}{2} ( {( K 2 )}^{2} - {( K 1 )}^{2} )} cos ( K {4}^{′} ) \qquad ( 14 A )$$

Based on the third coefficient X[2p] of the discrete Fourier transform DFT and the fifth correction coefficient K5, the fourth correction coefficient K4 is calculated according to equation (15). In the exemplary embodiment shown, the first correction coefficient K1 and the second correction coefficient K2 are 18 [sic] also taken into account when calculating the improved fourth correction coefficient K4′ in accordance with equation (15A).

$$K 4 = 2 Re \{ X [ 2 p ] {e}^{- i 2 ( K 5 )} \} \qquad ( 15 )$$

$$K {4}^{′} = 2 ( Re \{ X [ 2 p ] {e}^{- i 2 ( K 5 )} \} + ( K 1 ) ( K 2 ) ) \qquad ( 15 A )$$

$$vK 4 = K {4}^{′} - ( \frac{1}{12} {( K {4}^{′} )}^{3} ) \qquad ( 15 B )$$

In addition, a third power of the improved fourth correction coefficient K4 can be used when calculating a further improved fourth correction coefficient vK4 according to equation (15B). This allows a lower residual error to be achieved in the case of large orthogonality errors. For further improvement, a tangent function can also be applied to K4 or K4′.

When calculating the third and fourth correction coefficients K3, K4 as well as the improved third and fourth correction coefficients K3′, K4′ and the further improved fourth correction coefficient vK4, the fifth correction coefficient K5 is used in each case to compensate for the influence of the mean angular deviation. Alternatively, this can also be done by already compensating the calculation of the angular error dWⱼ with a correction coefficient similar to the fifth correction coefficient K5, which is determined, for example, by an additional prior calculation of the angular error dWⱼ.

As is further evident FIG. 3, the sensor unit 3 provides three current measurement signals MS1, MS2, MS3 based on a current scan or measurement in the exemplary embodiment shown. When conditioning the three current measurement signals MS1, MS2, MS3, the first transform block 12 performs the Clarke transform of the three currently provided measurement signals MS1, MS2, MS3 and transforms them into a first conditioned measurement signal a based on a periodic sine function with a predetermined period p and into a second conditioned measurement signal b based on a periodic cosine function with the predetermined period p. Here, the first conditioned measurement signal a is assigned to the sine channel 12.1 and the second conditioned measurement signal b is assigned to the cosine channel 12.2.

As can be further seen from FIG. 3, in the exemplary embodiment shown, a correction block 20 generates the first corrected measurement signal ac according to equation (16) based on the processed current first measurement signal a, the processed current second measurement signal b, the first correction coefficient K1, the second correction coefficient K2, the third correction coefficient K3 and the fourth correction coefficient K4. The correction coefficients K1, K2, K3, K4 are provided by the memory unit 18.

$$ac = ( K 3 ( a - K 1 ) ) - ( K 4 ( b - K 2 ) ) \qquad ( 16 )$$

Based on the processed current second measurement signal b and the second correction coefficient K2, the correction block 20 generates the second corrected measurement signal bc according to equation (17). Here, the second correction coefficient K2 is provided by the memory unit 18.

$$bc = ( b - K 2 ) \qquad ( 17 )$$

In an advantageous way, the calculation of the corrected conditioned second measurement signal bc from equation (17) can be reused in equation (16). In the output block 22, the corrected angle WK is calculated from the corrected measurement signals ac, bc and output. Here, a remaining angular error dW in the corrected angle WK is smaller than an angular error dW in an angle based on the two conditioned but uncorrected measurement signals a, b. In addition, an angular offset in the corrected angle WK can be compensated for with the fifth correction coefficient K5.

What is claimed is:

1. A method for correcting at least two measurement signals, comprising:
currently providing at least two currently provided measurement signals by at least one sensor unit;
based on the at least two currently provided measurement signals (i) generating at least two processed measurement signals, and (ii) generating two corrected measurement signals from the at least two processed measurement signals using angle-independent calculation operations and at least one correction coefficient, from which a corrected angle is calculated; and
in order to determine the at least one correction coefficient (i) a plurality of advance provided measurement signals is provided in advance, (ii) based on the plurality of advance provided measurement signals, two processed advance measurement signals are generated, (iii) a corresponding angular error is calculated based on the two processed advance measurement signals and a reference angle, (iv) at least one correction parameter is determined based on at least one step of an iteratively applicable calculation method, and (v) based on the at least one correction parameter, the at least one correction coefficient is determined, such that a remaining angular error in the corrected angle is smaller than an angular error in an angle based on the at least two processed measurement signals.

2. The method according to claim 1, wherein when processing the plurality of advance provided measurement signals and/or the at least two currently provided measurement signals, a transform and/or filtering of the plurality of advance provided measurement signals and/or the at least two currently provided measurement signals is performed.

3. The method according to claim 1, wherein:
a first processed advance provided measurement signal from the plurality of advance provided measurement signals and a first processed currently provided measurement signal from the at least two currently provided measurement signals are each (i) based on a periodic sine function with a predetermined period, and (ii) assigned to a sine channel, and
a second processed advance provided measurement signal from the plurality of advance provided measurement signals and a second processed currently provided measurement signal from the at least two currently provided measurement signals are each (i) based on a periodic cosine function with the predetermined period and (ii) assigned to a cosine channel.

4. The method according to claim 1, wherein the corresponding angular error is minimized by the at least one correction coefficient determined by iterative application of the iteratively applicable calculation method.

5. The method according to claim 1, wherein:
an iterative Newton method is used as the iteratively applicable calculation method, and
the iterative Newton method is based on a first partial derivative of a sum of squares of the corresponding angular error with respect to the at least one correction parameter, a quantity based thereon, or an approximation of a quantity based thereon.

6. The method according to claim 5, wherein determination of the at least one correction parameter is based on at least one division of at least two cumulative sums.

7. The method according to claim 6, wherein the at least two cumulative sums are based on the plurality of advance provided measurement signals, a previous correction parameter, the at least one correction parameter, and/or the corresponding angular error.

8. The method according to claim 7, wherein a number of steps of the iterative Newton method is fixedly predetermined.

9. The method according to claim 7, wherein a number of steps of the iterative Newton method depends on an evaluation of the corresponding angular error.

10. The method according to claim 9, wherein the evaluation of the corresponding angular error comprises an evaluation of harmonic components of the corresponding angular error.

11. The method according to claim 7, wherein a number of steps of the iterative Newton method depends on an evaluation of the at least one correction parameter determined in successive steps of the iterative Newton method.

12. The method according to claim 11, wherein an initial correction parameter is predetermined before a first step of the iterative Newton method.

13. The method according to claim 12, wherein:
the corresponding angular error is included in a plurality of corresponding angular errors,
the plurality of corresponding angular errors or the at least one correction parameter determined in successive steps of the iterative Newton method are subjected to at least one mathematical operation during the evaluation of the at least one correction parameter,
a result of the at least one mathematical operation is compared with a corresponding threshold value, and
the iterative Newton method is terminated when the result of the at least one mathematical operation falls below the corresponding threshold value.

14. The method according to claim 5, wherein the iterative Newton method applies a diagonal approximation of an inverse Hessian matrix or an approximation of the diagonal approximation of the inverse Hessian matrix.

15. The method according to claim 14, wherein the at least one correction coefficient includes at least two correction coefficients, which are suitable for compensating a portion of the corresponding angular error based on a harmonic oscillation having a predetermined order.

16. The method according to claim 15, wherein the at least one correction coefficient further includes at least one further correction coefficient, which is suitable for compensating another portion of the corresponding angular error based on the harmonic oscillation of the predetermined order.

17. The method according to claim 15, wherein the at least one correction coefficient further includes at least one further correction coefficient, which is suitable for compensating for a component of the corresponding angular error based on the harmonic oscillation of the predetermined order.

18. The method according to claim 14, wherein:
the corresponding angular error is subjected to a discrete Fourier transform (“DFT”),
the at least one correction coefficient includes at least one further correction coefficient determined based on coefficients of the DFT, and
the at least one further correction coefficient is suitable for compensating at least one component of the corresponding angular error based on a harmonic oscillation having a predetermined order.

19. The method according to claim 18, wherein:
the at least one correction coefficient includes at least one additional correction coefficient, which is suitable for compensating for a portion of the corresponding angular error based on an angular offset error.

20. A sensor array, comprising:
the at least one sensor unit; and
at least one evaluation and control unit configured to perform the method according to claim 1.
